(19) United States
(12) Patent Application Publication
(10) Pub. No.: US 2008/0199394 A1
(43) Pub. Date: Aug. 21, 2008

(54) Method for obtaining the nano-scale acicular oxidation compound powder

(75) Inventors: Hsin-Chun Lu, Tao-Yuan (TW); Mei-Ching Chiang, Tao-Yuan (TW); Kai-Yi Wang, Tao-Yuan (TW); Yu-Hsiang Lin, Tao-Yuan (TW)

Correspondence Address: BACON & THOMAS, PLLC, 625 SLATERS LANE, FOURTH FLOOR, ALEXANDRIA, VA, 22314, US

(73) Assignee: Chang Gung University, Tao-Yuan (TW)

(21) Appl. No.: 11/706,233

(22) Filed: Feb. 15, 2007

(51) Int. Cl. C01G 19/02

(52) U.S. Cl. 423/618

(57) ABSTRACT

The invention, firstly, SnCl₄ and SbCl₃ are collected as raw materials and all dissolved into water and hydrochloric acid with precipitation. Secondly, NaOH or NH₄0H can be used for adjusting the pH value. Then, aging, water-washing, filtering and drying process are all carried out. The additive also can be put into and sintering process is applied. Furthermore, washing and drying process are used for obtaining the crystalline nano-level acicular ATO composition powder.

### BACKGROUND OF THE INVENTION

1. Field of the Invention

The invention relates to obtaining the nano-scale acicular oxidation compound powder, more particularly for applying to obtaining the nano-scale acicular antimony doped tin oxide compound powder.

2. Description of the Prior Art

The antimony doped tin oxide (ATO) compound is one sort of antimony doped SnO₂, when the semiconductor is formed with the antimony doping quantity between 2% to 7%, it has not only some similar metal property, but also has the specific optics and the electricity characteristic, thus mainly uses as the air-sensitive ceramic materials, the infrared absorption materials, the photoelectric materials as well as the conductivity materials.

However, the nano-scale antimony doped tin oxide compound is a sort of ultra-fine powder-like body materials, can be concentrated the all advantage of the antimony oxide compound material and the nano-scale powders, as one kind of functional conductivity material. As one sort of the transparent conductivity oxide compound, the antimony compound oxide compound also can be made as the transparent thin film, become one sort of important transparent conductivity membrane material, being possible to make so-called conductive glass.

Due to associate with the good conductivity and the light permeability, for the photo-electricity components, the optics memory, the building glass, the liquid crystal display, the transparent electrode material as well as for the solar energy use, the catalysis and so on, the antimony doped tin oxide compound can be used to the domain widespread application filed, also is one kind of the new development potential conductivity material. Simultaneously, due to the antimony doped tin oxide compound powder having good wear-resisting property, high specific gravity, high dispersion as well as anti-radiation, infrared absorption, so that the antimony doped tin oxide compound powder can be widely used and applied as the coating raw materials and the pulp raw materials, as the anti static-electricity plastics, the texture, the coating as well as the anti radiation static-electricity coating material of the monitor display.

In general conventional manufacturing system, as American U.S. Pat. No. 5,788,887, “Antimony doped tin oxide electro conductive powder”, as well as U.S. Pat. No. 5,788,913 “Processes to prepare antimony doped tin oxide electro conductive powders”, in the previous two patents, the Du Pont Company although proposed the completely domain process method in the manufacturing related fields. However, excepting the bigger particle size been made, also the nano-scale antimony doped tin oxide compound can not been produced, also, not been produced as the acicular-like shape powder.

Another, by the Japanese Ishihara Sangyo Kaisha, ltd, proposes the Taiwan invention patent No.00,440,544, “the conductivity components”, and patent No.00,455,568, “Method for forming the acicular electric-conductive tin oxide compound fine grain”, even pointed out the manufacturing acicular conductivity tin oxide compound being fine grain, however, in the previous two patents, there were still not provided about any antimony doped tin oxide compound manufacturing related methods.

### SUMMARY OF THE INVENTION

In accordance with the present invention, a method is provided for obtaining the nano-scale acicular antimony doped tin oxide compound powder.

In view of this invention, forming the antimony oxide compound using the nano-scale process has developed the related process for the industry use, also, under the suitable product process, effectively reducing the powder production cost, and reducing the ecology pollution. Thus, the related process steps state as followings:

Under the vacuum environment, the scale can be used for the precisely measuring the weight of the tin chloride and the antimony chloride. After measuring process, the water and the hydrochloric acid separately been put together as dissolves, and been evenly stirred as one sort of the mixture solution.

The precipitating agent such as sodium hydroxide (NaOH), or the ammonia water (NH₄OH) are all put into the previous solution, and been adjusted the pH value, processed the aging procedure. The precipitating agent such as sodium hydroxide or the ammonia water for mixing and adjusting the pH value of the mixture solution, will achieve the suitable pH value.

The right amount sodium silicate (NaSi₂O₃) solution will be put into the mixture solution, then, again, the precipitating agent such as sodium hydroxide or the ammonia water will be put into the mixture solution for adjusting the pH value, achieving the suitable pH value. At this time, the precipitation fluid of the previous mixture solution will be produced, and after filtering the previous precipitation fluid of the mixture solution, the filtering cake can be obtained.

The previous filtering cake can be put into the de-ionized water to be dispersed, again, repeating the filtering step and the water-washing step several times. After repeating this step, the concentration of the chloride ion (Cl—) can be highly reduced.

Then, the obtained precipitations after the filtering and water-washing process can be put into the drying oven for drying process.

The right amount sodium chloride (NaCl) can be taken with the dried the antimony oxide compound powder together, all can be put into the ball milling equipment for processing the ball milling process, so that the crystal grain can be smaller and finer.

The mixed precipitations, having the antimony doped tin oxide compound powder and the sodium chloride all will be put together into the high temperature stove for sintering process, then the antimony oxide compound powder will be obtained.

The previous antimony doped tin oxide compound powder can be put into the de-ionized water, and then be filtered and removed the other impurity. In this step, this invention uses the water-washing instead of the hydrofluoric (HF) acid washing for the prior art, so that increasing the technical difficulty.

Finally, the drying procedure will be carried out, the water-washed antimony doped tin oxide compound powder will be put into the drying oven, then the crystalline nano-scale acicular antimony doped tin oxide compound powder will be obtained.

Without increasing the production process, this invention can effectively reduce the production cost by adjusting the pH value, companying with water-washing for the process improvement, furthermore, this invention also can replace the conventional chemical cleaning process.

Furthermore, after repeating many water-washing steps for this invention, not only the invention can reduce the production cost, but also may reduce the environment pollution under the manufacturing procedure processing, and then can avoid the ecology pollution.

The nano-scale acicular powder can be produced by this invention; also the previous acicular powder shape can increase the contacted area between the acicular powder and acicular powder, increase the conductivity efficiency, and then expand the application field of the market.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow-chart schematically illustrating the embodiment of the invention;

FIG. 2 is the X-ray diffraction (XRD) analysis mapping result for the invention; and

FIG. 3 is the result of the scanning electron microscope (SEM) analysis for the invention.

### DESCRIPTION OF THE PREFERRED EMBODIMENT

The following is a description of the present invention. The invention will firstly be described with reference to one exemplary structure. Some variations will then be described as well as advantages of the present invention. A preferred method of fabrication will then be discussed. An alternate, asymmetric embodiment will then be described along with the variations in the process flow to fabricate this embodiment.

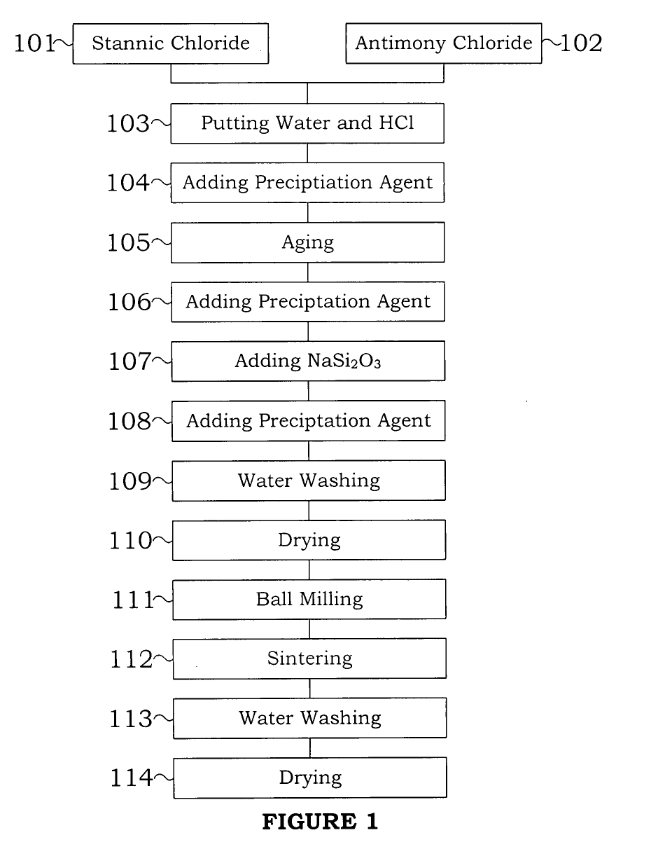

The detailed step of this invention will be described as followings, referring the FIG. 1 as the flow chart of this invention:

Such as FIG. 1, designating numeral 101, under the vacuum environment, the scale for precisely measuring the stannic chloride including stannic chloride anhydrous ( SnCl₄), or the stannic chloride pentahydrate ( SnCl₄— 5H₂O) can be alternatively taken. As FIG. 102, the antimony chloride including alternatively antimony trichloride (SbCl₃), or antimony pentachloride (SbCl₅) can be taken to the erlenmeyer flask with the covering and sealing by the parafilm, in order to avoid the unnecessary oxidation happening.

As FIG. 1, designating numeral 103, the stannic chloride and the antimony chloride from the previous step operated both are put into the water and the hydrochloric acid, and then evenly stirred as the mixture solution.

As FIG. 1, designating numeral 104, the precipitation agent such as sodium hydroxide (NaOH), or the ammonia water (NH₄OH) are both put or added into the previous mixture solution, and been adjusted the pH value into between 0.4 to 0.6, pH value as 0.5 will be preferred.

As FIG. 1, designating numeral 105, the mixture solution will be processed by the aging procedure, time to be about 4 to 8 hours.

As FIG. 1, designating numeral 106, the precipitation agent such as sodium hydroxide or the ammonia water will be added for mixing and adjusting the pH value of the mixture solution, achieving the suitable pH value, about from 6.5 to 7.5, the preferring pH value will be 7. The adjusted pH value will be approached to neutrality.

Next, as FIG. 1, designating numeral 107, the right amount sodium silicate (NaSi₂O₃) solution will be put into the mixture solution and evenly stirred, the temperature will be controlled between 80° C. to 100° C., especially the 90° C. will be the preferred.

As FIG. 1, designating numeral 108, the precipitation agent such as sodium hydroxide or the ammonia water will be put into the mixture solution for adjusting the pH value of the mixture solution, achieving the suitable pH value, the pH value will be at 3 to 8. At this time, the precipitation fluid of the previous mixture solution will be produced, and after filtering the previous precipitation fluid of the mixture solution, the filtering cake can be obtained.

Such as FIG. 1, designating numeral 109, the previous filtering cake can be put into the de-ionized water as water-washing process to be dispersed; again, repeating the filtering process and the water-washing process several times, the precipitation compound powder can be obtained. After repeating the filtering process and the water-washing process, the concentration of the chloride ion (Cl—) can be reduced. Therefore, after repeating the filtering process and the water-washing process for this invention, not only the environment pollution can be avoided, but also the component percentage portion of the antimony doped tin oxide compound for the filtering cake can be precisely controlled. In this step, this invention uses the water-washing process instead of the hydrofluoric (HF) acid washing process for the prior art, also increasing the technical difficulty.

As FIG. 1, designating numeral 110, after the filtering process and the water-washing process, the obtained precipitations having the compound powder can be put into the drying oven for drying process. The controlling condition for the drying temperature will be 125° C. to 95° C., for the drying time will be 10 hours to 14 hours. The preferred drying temperature will be 105° C., the preferred drying time will be 12 hours. Thus, the drying precipitations, such as the antimony doped tin oxide compound powder can be obtained.

As FIG. 1, designating numeral 111, the right amount sodium chloride (NaCl) can be taken with the dried antimony doped tin oxide compound powder together; all can be put into the ball mill equipment for carried out the ball milling process, so that the crystal grain can be smaller and finer. The added sodium chloride companying with the antimony oxide compound powder not only can assist for achieving the grinder effect, but also it is easy to be dispersed in the water, not causing any environment pollution.

Shown as FIG. 1, designating numeral 112, the mixed precipitations, having the antimony doped tin oxide compound powder and the sodium chloride all will be put together into the high temperature stove for sintering, the sintering temperature will be about 775° C. to 975° C., the sintering time will be 1 hour to 10 hours, i.e. the controlling condition for the preferred sintering temperature is about 875° C., the preferred sintering time will be 1 hour to 7 hours, then the antimony oxide compound powder will be obtained.

As FIG. 1, designating numeral 113, the mixed antimony doped tin oxide compound powder can be put into the de-ionized water, and then be filtered and removed the impurity.

Finally, as FIG. 1, designating numeral 114, the drying procedure will be carried out, the washed antimony doped tin oxide compound powder will be put into the drying oven for drying process, the drying temperature will be about 125° C. to 95° C., the drying time will be 10 hour to 14 hours, i.e. the controlling condition for the preferred drying temperature is about 105° C., the preferred drying time will be 12 hours, then, the dried precipitations can be obtained, the crystalline nano-scale acicular antimony doped tin oxide compound powder will be obtained.

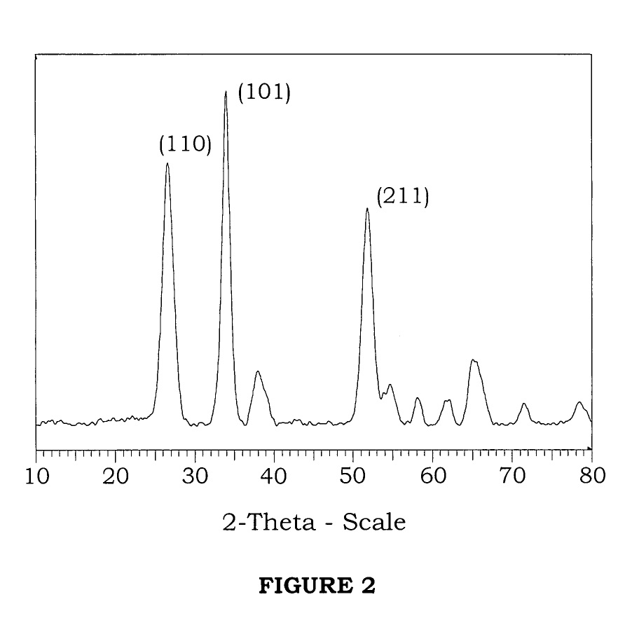

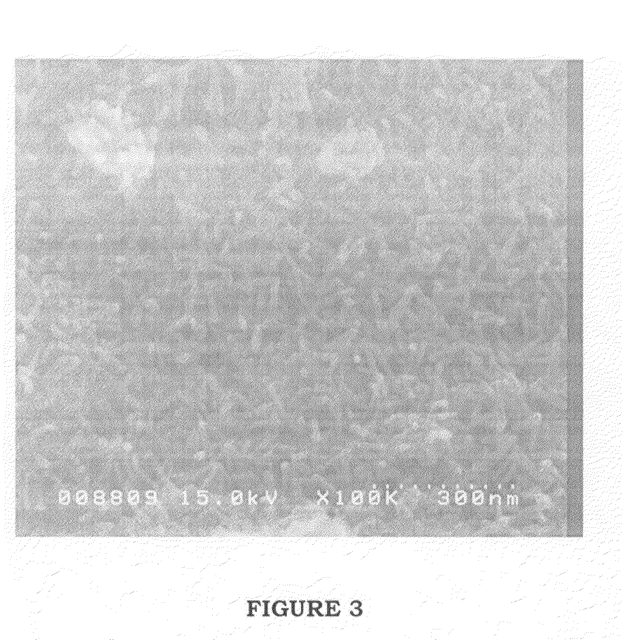

Finally, by the related chemistry instruments checking out, as FIG. 2 is shown as the X-ray diffraction (XRD) analysis mapping result by the X-ray diffraction examination, and as the FIG. 3 shown the result of the scanning electron microscope (SEM) analysis, there exactly are the nano-scale acicular antimony doped tin oxide compound powder production existed by this invention. Observing the powder size of the crystalline nano-scale acicular antimony doped tin oxide compound of this invention, the length for the size will be approximately about 60 nm to 75 nm, also the width of the size will be about 10 nm to 20 nm, the length times the width approximately about 3 to 7.5, therefore the powder shape is very similar as the acicular shape.

In this invention, due to the produced antimony doped tin oxide compound powder having the crystalline nano-scale acicular shape, especially due to the previous powder shape is similar with acicular shape. Therefore, the acicular shape powder do not need overlapping each other, on the other word, the whole acicular shape powder can easily been contacted each other between every acicular powder, and then the overlap frequency of the acicular powder can been increased, so that the conductivity will be increased.

In the industry application field, the antimony doped tin oxide compound thin film (ATO Film) could be used for the conductivity glass raw materials of the electric-capacity type touch-controlling panel and the anti static-electricity coating raw materials.

The antimony doped tin oxide compound thin film also can be used as the touch-controlling panel technology; normally touch-controlling panel will be made by all glasses. The conductivity glass of the electric-capacity type touch-controlling panel normally is made by the antimony doped tin oxide compound thin film layer and the hard coat layer. Between the previous glasses and the liquid crystal display monitor, the shielded layer should be carried out for protecting the electric signature interference under the manufacturing process. The production character can have the following characters for water-resist, scratching protection, high transparency, high-temperature protection and atrociously-environment protection. In the banking ATM application, the public information touch-controlling panel field, the antimony doped tin oxide compound thin film will be more popular and welcome.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A method for obtaining the nano-level acicular oxidation compound powder, comprising:
providing a stannic chloride and an antimony chloride, putting into a water and a hydrochloric acid, evenly stirring the stannic chloride and the antimony chloride as a first mixture solution, putting a precipitation agent into the first mixture solution for adjusting the first mixture solution having a pH value, aging the first mixture solution;
adding the precipitation agent for mixing and adjusting the first mixture solution having a second pH value;
putting a sodium silicate (NaSi₂O₃) solution into the first mixture solution, evenly stirring as a second mixture solution at a certain temperature;
putting the precipitation agent into the second mixture solution for adjusting the second mixture solution having a third pH value, producing a precipitation fluid of the second mixture solution, filtering the precipitation fluid of the second mixture solution for obtaining a filtering cake;
putting into a de-ionized water as a water-washing process to the filtering cake to be dispersed, repeating the filtering process and the water-washing process, obtaining a precipitation compound powder, drying the precipitation compound powder;
ball milling the precipitation compound and a sodium chloride (NaCl) together;
sintering the precipitation compound powder and the sodium chloride as an oxidation compound powder; and
water-washing the mixed oxidation compound powder, drying the mixed oxidation compound powder to be obtained a crystalline nano-scale acicular antimony doped tin oxide compound powder.

2. The method according to the claim 1, wherein the precipitation agent comprises sodium hydroxide (NaOH), or ammonia water (NH₄OH).

3. The method according to the claim 1, wherein the first pH value is between about 0.4 to 0.6.

4. The method according to the claim 1, wherein the second pH value is between about 6.5 to 7.5.

5. The method according to the claim 1, wherein the third pH value is between about 3 to 8.

6. The method according to the claim 1, wherein the sintering condition comprises temperature being about between 775° C. to 975° C., time being about between 1 hour to 10 hours.

7. A method for obtaining the nano-level acicular oxidation compound powder, comprising:
providing a stannic chloride and an antimony chloride;
putting into a water and a hydrochloric acid for evenly stirring the stannic chloride and the antimony chloride as a first mixture solution;
putting a precipitation agent into the first mixture solution for adjusting the first mixture solution having a pH value;
aging the first mixture solution;
adding the precipitation agent for mixing and adjusting the first mixture solution having a second pH value;
putting a sodium silicate (NaSi2O3) solution into the first mixture solution, evenly stirring as a second mixture solution at a certain temperature;
putting the precipitation agent into the second mixture solution for adjusting the second mixture solution having a third pH value, producing a precipitation fluid of the second mixture solution, filtering the precipitation fluid of the second mixture solution for obtaining a filtering cake;
putting into a de-ionized water as a water-washing process to the filtering cake to be dispersed, repeating the filtering process and the water-washing process, obtaining a precipitation compound powder;
drying the precipitation compound powder;
ball milling the precipitation compound and a sodium chloride (NaCl) together;
sintering the precipitation compound powder and the sodium chloride as an oxidation compound powder;
water-washing the mixed oxidation compound powder; and
drying the mixed oxidation compound powder to be obtained a crystalline nano-scale acicular antimony doped tin oxide compound powder.

8. The method according to the claim 7, wherein the stannic chloride comprises stannic chloride anhydrous (SnCl₄), or stannic chloride pentahydrate (SnCl₄— 5H₂O).

9. The method according to the claim 7, wherein the antimony chloride comprises antimony trichloride (SbCl₃), or antimony pentachloride (SbCl₅).

10. The method according to the claim 7, wherein the precipitation agent comprises sodium hydroxide (NaOH), or ammonia water (NH₄OH).

11. The method according to the claim 7, wherein the first pH value is between about 0.4 to 0.6.

12. The method according to the claim 7, wherein the time for aging the first mixture solution is between about 4 hours to 8 hours.

13. The method according to the claim 7, wherein the second pH value is between about 6.5 to 7.5.

14. The method according to the claim 7, wherein the certain temperature is between about 80° C. to 100° C.

15. The method according to the claim 7, wherein the third pH value is between about 3 to 8.

16. The method according to the claim 7, wherein the drying condition comprises temperature being about between 125° C. to 95° C., time being about between 10 hour to 14 hours.

17. The method according to the claim 7, wherein the drying condition comprises temperature being about between 125° C. to 95° C., time being about between 10 hour to 14 hours.

18. The method according to the claim 7, wherein the nano-scale acicular antimony doped tin oxide compound powder comprises the length proportion times the width approximately about 3 to 7.5.
